(19) United States
(12) Patent Application Publication
(10) Pub. No.: US 2026/0189170 A1
(43) Pub. Date: Jul. 2, 2026

(54) MOTOR DRIVE DEVICE

(71) Applicant: ALPS ALPINE CO., LTD., Tokyo (JP)

(72) Inventor: Akira YAMAMOTO, Miyagi (JP)

(21) Appl. No.: 19/545,961

(22) Filed: Feb. 20, 2026

Related U.S. Application Data
(63) Continuation of application No. PCT/JP2024/008419, filed on Mar. 6, 2024.

(30) Foreign Application Priority Data
Sep. 28, 2023 (JP) 2023-168410

(51) Int. Cl. H02P 29/032; E05F 15/697

(52) U.S. Cl. CPC H02P 29/032; E05F 15/697; E05Y 2900/55

(57) ABSTRACT

A motor drive device includes first and second switchers that switch to connect first and second terminals of a motor to a first power source or a reference potential point; first and second operation switches; first and second switching elements; a third switching element connected to the second switching element; a controller; and a water ingress detection circuit that includes a fourth switching element and switches the first and second switchers according to a water ingress detection signal. The first operation switch is connected to the third switching element and controller, and is connected to the first power source via the fourth switching element and to a second power source. When the first operation switch is operated in water ingress, the first power source is connected to the third switching element and the third switching element operates the second switching element to rotate the motor in a first direction.

### CROSS-REFERENCE TO RELATED APPLICATIONS

This application is a continuation application of International Application No. PCT/JP2024/008419 filed on March 6, 2024, and designating the U.S., which is based upon and claims priority to Japanese Patent Application No. 2023-168410 filed on September 28, 2023, the entire contents of which are incorporated herein by reference.

### BACKGROUND

### 1. Technical Field

The present disclosure relates to a motor drive device.

### 2. Description of the Related Art

In the related art, a motor drive device including a first switching unit that switches to connect one end of a motor to a power source or ground; a second switching unit that switches to connect the other end of the motor to the power source or ground; a first operation switch operated when the motor is rotated in one direction; a second operation switch operated when the motor is rotated in the other direction; a first switching element that drives the first switching unit to connect the one end of the motor to the power source and connect the other end to the ground when the first operation switch is operated; a second switching element that drives the second switching unit to connect the one end of the motor to the ground and connect the other end to the power source when the second operation switch is operated; a control unit that causes the first switching element to operate based on the operation of the first operation switch and causes the second switching element to operate based on the operation of the second operation switch; a water ingress detection circuit that detects water ingress and output a water ingress detection signal to cause each of the switching elements to operate by applying the water ingress detection signal to a control terminal of the first switching element and a control terminal of the second switching element, and a third switching element that is connected between the control terminal of the second switching element and the first operation switch and that operates when the first operation switch is operated while the water ingress detection circuit is outputting the water ingress detection signal and inhibits the operation of the second switching element. In the third switching element, a control terminal (a base) is connected to the water ingress detection circuit, and an emitter is connected to the first operation switch (for example, see Patent Document 1).

### Related Art Document

### Patent Document

Patent Document 1: Japanese Laid-Open Patent Application Publication No. 2013-249724

### SUMMARY

A motor drive device according to an embodiment of the present disclosure includes a first switcher configured to switch to connect one terminal among a first terminal and a second terminal of a motor to a first power source or a reference potential point; a second switcher configured to switch to connect another terminal among the first terminal and the second terminal of the motor to the first power source or the reference potential point; a first operation switch operated when the motor is caused to rotate in a first direction; a second operation switch operated when the motor is caused to rotate in a second direction; a first switching element configured to drive the first switcher; a second switching element configured to drive the second switcher; a third switching element connected to the second switching element; a controller configured to operate the first switching element based on an operation of the first operation switch and operate the second switching element based on an operation of the second operation switch; and a water ingress detection circuit configured to output a water ingress detection signal in response to detecting water ingress and switch the first switcher and the second switcher by operating the first switching element and the second switching element in accordance with the water ingress detection signal. The water ingress detection circuit includes a fourth switching element configured to operate in the presence of water ingress and output the water ingress detection signal. One end of the first operation switch is connected to the third switching element and the controller, and another end of the first operation switch is connected to the first power source via the fourth switching element and connected to a second power source. When the first operation switch is operated in the presence of water ingress, the first power source is connected to the third switching element and the third switching element operates the second switching element to rotate the motor in the first direction.

### BRIEF DESCRIPTION OF THE DRAWINGS

FIG. 1 is a diagram illustrating an example of a configuration of a motor drive device of an embodiment;

FIG. 2A is a diagram illustrating an example of an operation of the motor drive device of the embodiment in a non-operating state with no water ingress;

FIG. 2B is a diagram illustrating an example of an operation of the motor drive device of the embodiment in a non-operating state with water ingress;

FIG. 3A is a diagram illustrating an example of an operation of the motor drive device of the embodiment in an UP operation with no water ingress;

FIG. 3B is a diagram illustrating an example of an operation of the motor drive device of the embodiment in an UP operation with water ingress;

FIG. 4A is a diagram illustrating an example of an operation of the motor drive device of the embodiment in a DOWN operation with no water ingress;

FIG. 4B is a diagram illustrating an example of an operation of the motor drive device of the embodiment in a DOWN operation with water ingress;

FIG. 5 is a diagram illustrating an example of a configuration of a motor drive device of a modified example of the embodiment;

FIG. 6A is a diagram illustrating an example of an operation of the motor drive device of the modified example of the embodiment in a non-operating state with no water ingress;

FIG. 6B is a diagram illustrating an example of an operation of the motor drive device of the modified example of the embodiment in a non-operating state with water ingress;

FIG. 7A is a diagram illustrating an example of an operation of the motor drive device of the modified example of the embodiment in an UP operation with no water ingress;

FIG. 7B is a diagram illustrating an example of an operation of the motor drive device of the modified example of the embodiment in an UP operation with water ingress;

FIG. 8A is a diagram illustrating an example of an operation of the motor drive device of the modified example of the embodiment in a DOWN operation with no water ingress; and

FIG. 8B is a diagram illustrating an example of an operation of the motor drive device of the modified example of the embodiment in a DOWN operation with water ingress.

### DETAILED DESCRIPTION

In a motor drive device (a power window device) in the related art, a third switching element including an NPN type transistor includes a control terminal (a base) connected to a water ingress detection circuit and a current output terminal (an emitter) connected to a first operation switch. A voltage from a battery is input to the current output terminal (the emitter) when the first operation switch is turned off, and 0 V is input to the current output terminal (the emitter) by being connected to ground when the first operation switch is turned on.

As described above, in the motor drive device (the power window device) in the related art, the potential of the current output terminal (the emitter) of the third switching element fluctuates greatly, and thus the operation of the third switching element becomes unstable and the circuit operation may become unstable.

A motor drive device that can achieve a stable circuit operation even when water ingress into the vehicle has occurred can be provided.

Hereinafter, an embodiment to which a motor drive device of the present disclosure is applied will be described.

### Embodiment

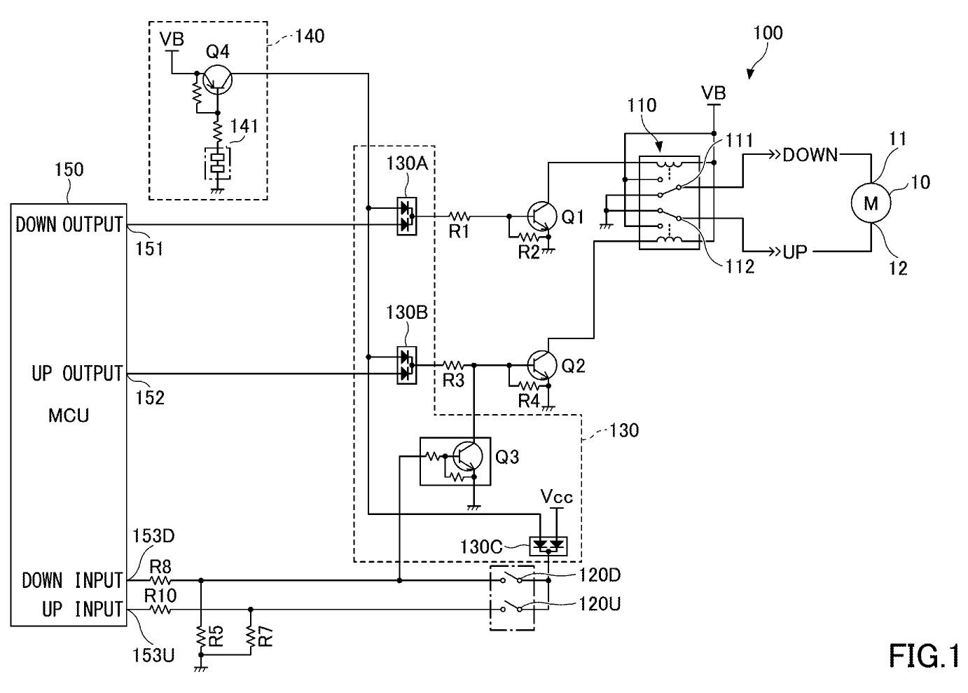

FIG. 1 is a diagram illustrating an example of a configuration of a motor drive device 100 according to the embodiment. The motor drive device 100 controls driving of a motor 10 that is mounted on a vehicle and that drives opening and closing of an opening and closing body such as a window of the vehicle. Here, a circuit configuration of the motor drive device 100 will be described with reference to FIG. 1.

The motor 10 includes terminals 11 and 12. The terminal 11 is an example of a first terminal, and the terminal 12 is an example of a second terminal. A direction in which the motor 10 is rotated when the window is opened (lowered) is an example of a first direction, and a direction in which the motor 10 is rotated when the window is closed (raised) is an example of a second direction.

When the window is opened (lowered), a current is input from a relay 111 to the motor 10 via the terminal 11, and the current flows in a direction from the terminal 12 toward a relay 112, as indicated by “>>DOWN” in the wiring. Additionally, when the window is closed (raised), a current is input from the relay 112 to the motor 10 via the terminal 12 as indicated by “>>UP” in the wiring, and the current flows in a direction from the terminal 11 toward the relay 111. The direction in which the motor 10 rotates when the window is opened (lowered) is an example of the first direction, and the direction in which the motor 10 rotates when the window is closed (raised) is an example of the second direction.

FIG. 1 illustrates a power source VB and a power source Vcc. The power source VB is an example of a first power source, and power is directly supplied from a battery of the vehicle. The voltage of the power source VB is, for example, 12 V. Even when water ingress into the vehicle has occurred, power is supplied to the power source VB from the battery.

The power source Vcc is an example of a second power source. The power source Vcc is a power source supplied by an on-vehicle IC (an integrated circuit) processing the power output from the vehicle battery. The on-vehicle IC is, for example, a micro controller unit (MCU) 150. The processing performed by the on-vehicle IC includes control processing of a regulator configured to step down the power output from the battery of the vehicle. The voltage of the power source Vcc is, for example, 5 V. The power source Vcc is not supplied when the on-vehicle IC is inoperable when water ingress into the vehicle has occurred. Here, the power source Vcc is not limited to 5 V and may be any voltage that can drive a transistor Q3 described later. The power source Vcc may be 12 V equal to the power source VB.

### Motor Drive Device 100

The motor drive device 100 includes a relay device 110, operation switches 120D and 120U, transistors Q1 and Q2, a water ingress control circuit 130, a water ingress detection circuit 140, and the MCU 150. The operation switch 120D is an example of a first operation switch, and the operation switch 120U is an example of a second operation switch. The transistor Q1 is an example of a first switching element, and the transistor Q2 is an example of a second switching element. The MCU 150 is an example of a controller.

### Relay device 110

The relay device 110 includes the relays 111 and 112, and is connected between the power source VB and the ground. The relay 111 is an example of a first switcher, and the relay 112 is an example of a second switcher. The ground is an example of a reference potential point. The relays 111 and 112 include electromagnetic coils and switching contacts. The relay 111 is connected to the terminal 11 of the motor 10, and connects the terminal 11 to either the power source VB or the ground. The relay 112 is connected to the terminal 12 of the motor 10, and connects the terminal 12 to either the power source VB or the ground.

The relays 111 and 112 are respectively switched by transistors Q1 and Q2. When the transistors Q1 and Q2 become non-conducting (off), the relays 111 and 112 are connected to the ground. The relay 111 is connected to the power source VB when the transistor Q1 is on. The relay 112 is connected to the power source VB when the transistor Q2 is on.

### Operation Switches 120D and 120U

The operation switch 120D is a switch operated by an operator when the window is opened (lowered), and the operation switch 120U is a switch operated by the operator when the window is closed (raised). The operation switches 120D and 120U are provided, for example, at a door or a center console in the interior of the vehicle.

Ends of the operation switches 120D and 120U (terminals on the left side in FIG. 1) are respectively connected to input terminals 153D and 153U of the MCU 150 via resistors R8 and R10. Resistors R5 and R7 are inserted in series on a line branched from intermediate points of two lines connecting the operation switches 120D and 120U to the input terminals 153D and 153U via the resistors R8 and R10 and are connected to the ground.

The other ends of the operation switches 120D and 120U (terminals on the right side in FIG. 1) are connected to the output terminal of a diode circuit 130C of the water ingress control circuit 130. The other ends of the operation switches 120D and 120U are connected to the power source VB and the power source Vcc via the diode circuit 130C.

### Transistors Q1 and Q2

The transistors Q1 and Q2 are, for example, NPN type bipolar transistors. The base of the transistor Q1 is connected to an output terminal of a diode circuit 130A of the water ingress control circuit 130 via a resistor R1, the collector is connected to the relay 111 of the relay device 110, and the emitter is connected to the ground.

The base of the transistor Q2 is connected to an output terminal of a diode circuit 130B of the water ingress control circuit 130 via a resistor R3, the collector is connected to the relay 112 of the relay device 110, and the emitter is connected to the ground. The base of the transistor Q2 is an example of a control terminal of the second switching element.

Here, operating the transistors Q1 and Q2 means switching the connection state (conducting or non-conducting) between the emitter and collector of each of the transistors Q1 and Q2 by controlling the voltage of the bases of the transistors Q1 and Q2. The same applies to the transistors Q3 and Q4.

### Water Ingress Control Circuit 130

The water ingress control circuit 130 includes diode circuits 130A, 130B, and 130C and the transistor Q3. The transistor Q3 is an example of a third switching element. The base of the transistor Q3 is an example of a control terminal of the third switching element. The water ingress control circuit 130 is a circuit configured to control the motor 10 to be drivable even if the MCU 150 becomes inoperable when water ingress into the vehicle has occurred.

Each of the diode circuits 130A, 130B, and 130C includes two diodes. In each of the diode circuits 130A, 130B, and 130C, the connection destinations of the anodes of the two diodes are different from each other, and the cathodes of the two diodes are connected to each other. Therefore, the diode circuits 130A, 130B, and 130C each output a signal corresponding to the logical sum of the signals input to the two anodes.

### Diode Circuit 130A

The anode of one diode (the upper side in FIG. 1) of the diode circuit 130A is connected to the collector of the transistor Q4 of the water ingress detection circuit 140, and more specifically, it is connected to the power source VB through the collector-emitter of the transistor Q4. The anode of the other diode (the lower side in FIG. 1) of the diode circuit 130A is connected to an output terminal 151 of the MCU 150. The output terminal 151 is a terminal configured to output a signal for lowering the window. The cathodes of the two diodes of the diode circuit 130A are connected to the base of the transistor Q1 via the resistor R1.

The diode circuit 130A can output, to the relay 111, power supplied from the power source VB via the water ingress detection circuit 140 even if the MCU 150 becomes inoperable when water ingress into the vehicle has occurred.

### Diode Circuit 130B

The anode of one diode (the upper side in FIG. 1) of the diode circuit 130B is connected to the collector of the transistor Q4 of the water ingress detection circuit 140, and more specifically, it is connected to the power source VB through the collector-emitter of the transistor Q4. The anode of the other diode (the lower side in FIG. 1) of the diode circuit 130B is connected to an output terminal 152 of the MCU 150. The output terminal 152 is a terminal configured to output a signal for raising the window. The cathodes of the two diodes of the diode circuit 130B are connected to the base of the transistor Q2 via the resistor R3.

The diode circuit 130B can output, to the relay 112, power supplied from the power source VB via the water ingress detection circuit 140 even if the MCU 150 becomes inoperable when water ingress into the vehicle has occurred.

### Diode Circuit 130C

One diode (the left side in FIG. 1) of the diode circuit 130C is an example of a first diode. The anode of the one diode (the left side in FIG. 1) of the diode circuit 130C is connected to the collector of the transistor Q4 of the water ingress detection circuit 140, and more specifically, it is connected to the power source VB through the collector-emitter of the transistor Q4.

The other diode (the right side in FIG. 1) of the diode circuit 130C is an example of a second diode. The anode of the other diode (the right side in FIG. 1) of the diode circuit 130C is connected to the power source Vcc. The cathodes of the two diodes of the diode circuit 130C are connected to the operation switches 120D and 120U.

The diode circuit 130C can output, to the base of the transistor Q3 via the operation switch 120D, power supplied from the power source VB via the water ingress detection circuit 140 even if the MCU 150 becomes inoperable and the power source Vcc is not supplied when water ingress into the vehicle has occurred. Additionally, when the voltage values of the power source VB and the power source Vcc are different, the diode circuit 130C can prevent reverse flow between the power source VB and the power source Vcc.

### Transistor Q3

The transistor Q3 is, as an example, an NPN type bipolar transistor. The base of the transistor Q3 is connected to one end (the terminal on the left side in FIG. 1) of the operation switch 120D, the collector is connected to the output terminal (the cathodes of two diodes) of the diode circuit 130B via the resistor R3 and is connected to the base of the transistor Q2, and the emitter is connected to the ground. The transistor Q3 is a switching element configured to switch the connection state between the base of the transistor Q2 and the ground.

### Water Ingress Detection Circuit 140

The water ingress detection circuit 140 includes the transistor Q4 and a water ingress detection section 141. The transistor Q4 is an example of a fourth switching element.

### Transistor Q4

The transistor Q4 is, for example, a PNP transistor. The base of the transistor Q4 is connected to the water ingress detection section 141, the collector is connected to the anode of one diode of each of the diode circuits 130A, 130B, and 130C of the water ingress control circuit 130, and the emitter is connected to the power source VB.

### Water Ingress Detection section 141

The water ingress detection section 141 is inserted in series between the base of the transistor Q4 and the ground, and includes two pads spaced apart from each other. For example, the water ingress detection section 141 is arranged at a predetermined height from a ground surface inside a motor drive device for a power window and the like. When water ingress into the vehicle has occurred, there is no electrical continuity between the two pads, a voltage is supplied to the base of the transistor Q4 from the power source VB via a resistor connected between the emitter and the base, and thus the emitter and collector of the transistor Q4 are non-conducting. When water ingress into the vehicle has occurred and a space between the two pads becomes electrically conductive due to the presence of water, the base of the transistor Q4 is connected to the ground, so that the transistor Q4 conducts between the emitter and the collector.

Therefore, the output of the water ingress detection circuit 140 becomes an H level when water ingress into the vehicle has occurred, because the transistor Q4 conducts. The H level output of the water ingress detection circuit 140 is an example of a water ingress detection signal. The transistor Q4 outputs a water ingress detection signal that is the H level output.

### MCU 150

The MCU 150 is implemented by a computer including a central processing unit (CPU), a random access memory (RAM), a read only memory (ROM), an input/output interface, an internal bus, and the like. The MCU 150 includes the output terminals 151 and 152, and the input terminals 153D and 153U.

The output terminal 151 is connected to the anode of the other diode (the lower side in FIG. 1) of the diode circuit 130A, and outputs a signal for lowering the window. Therefore, the output terminal 151 is labeled as “DOWN OUTPUT”. The output terminal 152 is connected to the anode of the other diode (the lower side in FIG. 1) of the diode circuit 130B, and outputs a signal for raising the window. Therefore, the output terminal 152 is labeled as “UP OUTPUT”.

The input terminal 153D is connected to one end (the terminal on the left side in FIG. 1) of the operation switch 120D via the resistor R8, and when the operation switch 120D is closed (turned on), an H level signal is input from the diode circuit 130A to which power is supplied from the power source Vcc or the power source VB. With this, the MCU 150 determines that the operation switch 120D has been operated (an operation for lowering the window has been performed). The input terminal 153D is labeled as “DOWN INPUT”.

The input terminal 153U is connected to one end (the terminal on the left side in FIG. 1) of the operation switch 120U via the resistor R10, and when the operation switch 120U is closed (turned on), an H level signal is input from the diode circuit 130A to which power is supplied from the power source Vcc or the power source VB. With this, the MCU 150 determines that the operation switch 120U has been operated (an operation for raising the window has been performed). The input terminal 153U is labeled as “UP INPUT”.

When the H-level signal is input to the input terminal 153D, the MCU 150 determines that the operation switch 120D has been operated and outputs a signal for lowering the window from the output terminal 151. When the H-level signal is input to the input terminal 153U, the MCU 150 determines that the operation switch 120U has been operated and outputs a signal for raising the window from the output terminal 152.

### Operation in Non-operating State with No Water Ingress

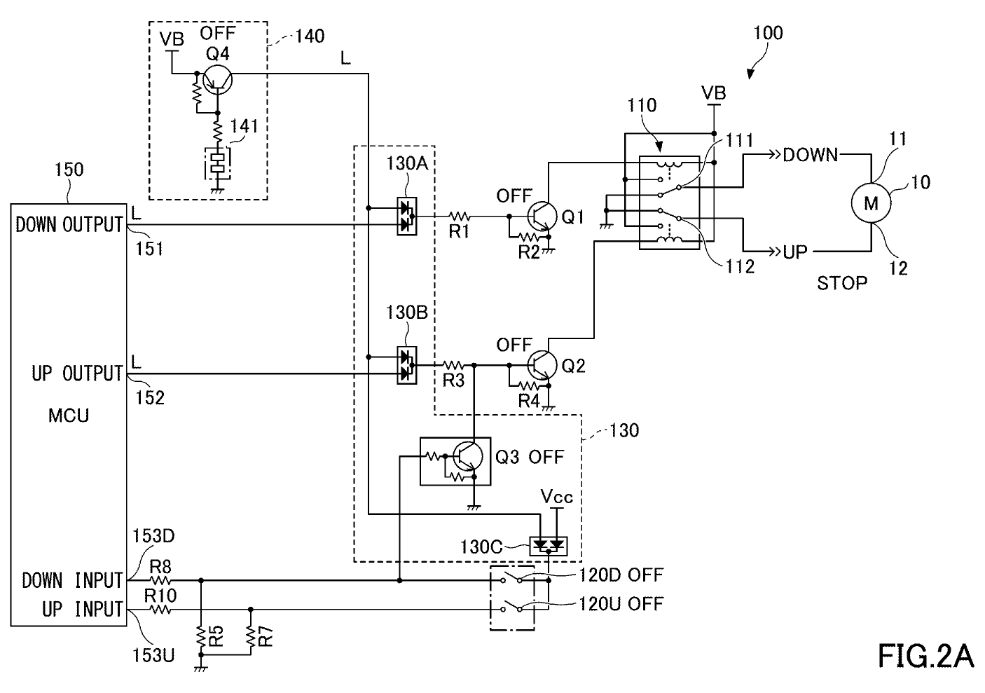

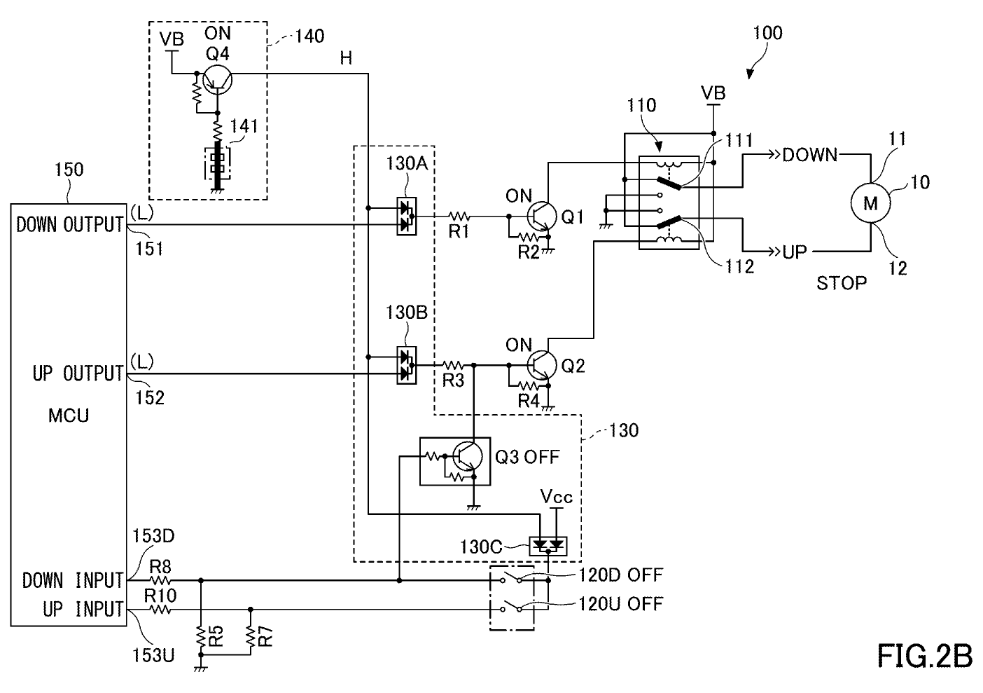

FIG. 2A is a diagram for explaining an example of an operation of the motor drive device 100 in a non-operating state with no water ingress. Non-water ingress indicates a state in which two pads of the water ingress detection section 141 of the water ingress detection circuit 140 are not conducting. The non-operating state indicates a state in which neither of the operation switches 120D and 120U is operated.

In the following description, with respect to the transistors Q1 to Q4, the state of non-conduction between the emitter and collector is referred to as “off”, and the state of conduction between the emitter and collector is referred as “on”. Additionally, rotation of the motor 10 in the second direction to raise the window is referred to as “forward rotation of the motor 10”, and rotation of the motor 10 in the first direction to lower the window is referred to as “reverse rotation of the motor 10”.

The MCU 150 can operate normally in non-water ingress, and thus the outputs of the output terminals 151 and 152 of the MCU 150 become the L (Low) level in the non-operating state with no water ingress. Additionally, the transistor Q4 of the water ingress detection circuit 140 is off because the base is at the H (High) level due to power being supplied from the power source VB via the resistor between the emitter and base. Therefore, the output of the water ingress detection circuit 140 is at the L level.

As a result, the output of the diode circuit 130A is at the L level, and the transistor Q1 is turned off. Additionally, the transistor Q3 is turned off because the input of the base is at the L level. Additionally, the output of the diode circuit 130B is at the L level, and the transistor Q2 is turned off.

When both the transistors Q1 and Q2 are turned off, the relays 111 and 112 are connected to the ground. Therefore, no current flows through the motor 10, and the motor 10 is stopped.

### Operation in Non-operating State with Water Ingress

FIG. 2B is a diagram for explaining an example of an operation of the motor drive device 100 in a non-operating state with water ingress. Water ingress indicates a state in which two pads of the water ingress detection section 141 of the water ingress detection circuit 140 are conducting.

In the non-operating state with water ingress, the outputs of the output terminals 151 and 152 of the MCU 150 become the L level if the MCU 150 operates normally, and become undefined, which is neither the H level nor the L level, if the MCU 150 is inoperable. Therefore, in FIG. 2B, the output levels of the output terminals 151 and 152 are labeled in parentheses.

Additionally, the base of the transistor Q4 of the water ingress detection circuit 140 becomes the L level by the two pads of the water ingress detection section 141 conducting, and thus the transistor Q4 is turned on. Therefore, the output of the water ingress detection circuit 140 becomes the H level based on the output of the power source VB.

As a result, the H level signal is supplied to the one diode of each of the diode circuits 130A and 130B (the upper side in FIG. 2B). That is, the H level signal is input to the one diode of each of the diode circuits 130A and 130B (the upper side in FIG. 2B) regardless of whether the MCU 150 is operating normally or not.

At this time, as this is a non-operating state, the input of the base of the transistor Q3 is at the L level, and thus the transistor Q3 is turned off. As a result, the bases of the transistors Q1 and Q2 are at the H level, and both the transistors Q1 and Q2 are turned on.

When both of the transistors Q1 and Q2 are turned on, both of the relays 111 and 112 are switched and connected to the power source VB. Therefore, the terminals 11 and 12 of the motor 10 are at the same potential and no current flows to the motor 10, and thus the motor 10 is stopped. In the non-operating state with water ingress, the motor 10 is stopped in a state in which power is supplied from the power source VB to both of the terminals 11 and 12 of the motor 10. The power source VB is directly connected to the battery of the vehicle, and thus power is supplied even in the presence of water ingress.

### Operation in UP Operation with No Water Ingress

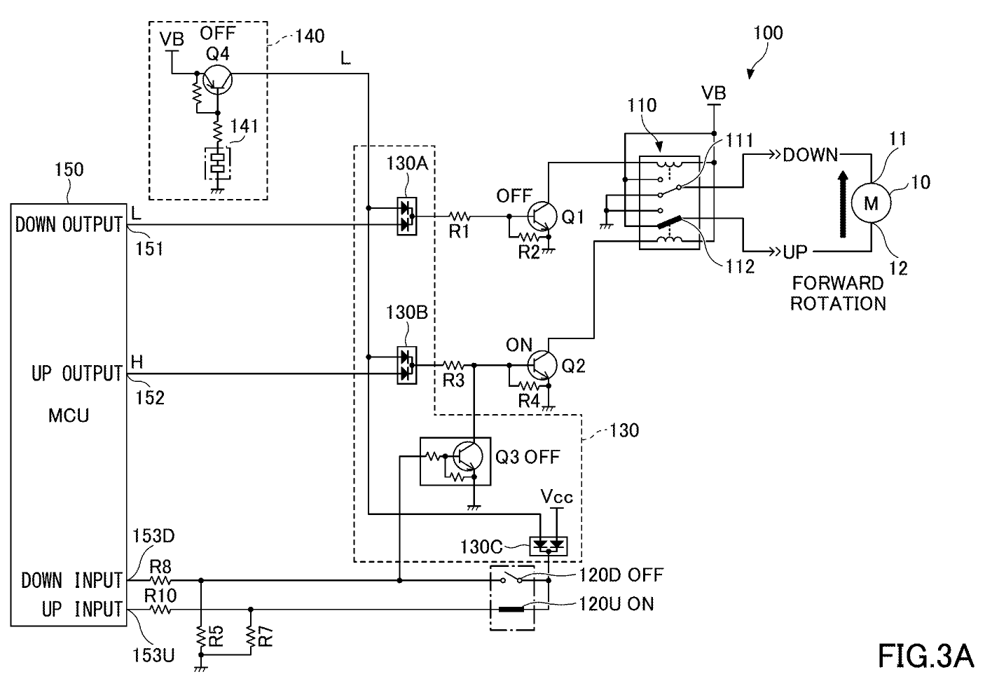

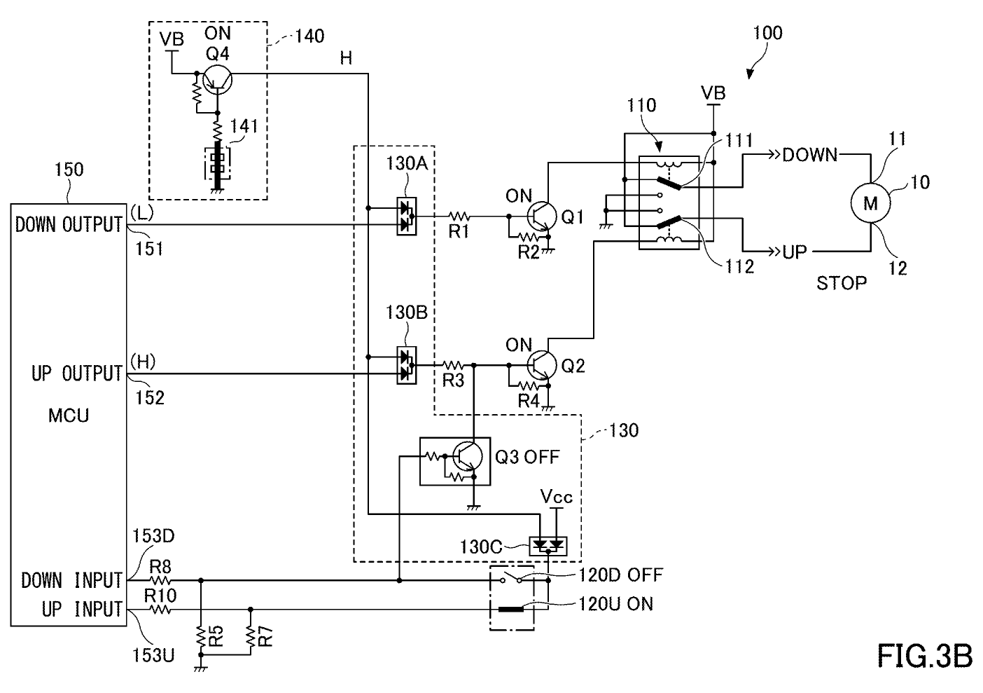

FIG. 3A is a diagram for explaining an example of an operation of the motor drive device 100 in an UP operation with no water ingress. The UP operation is an operation of the operator operating the operation switch 120U to raise the window.

The MCU 150 can operate normally in the absence of water ingress, and thus, in the UP operation with no water ingress, the MCU 150 determines that the UP operation is performed based on the input signal of the input terminal 153U, and sets the output of the output terminal 151 to the L level and the output of the output terminal 152 to the H level. Additionally, the transistor Q4 of the water ingress detection circuit 140 is turned off because the base is at the H level due to power being supplied from the power source VB via the resistor between the emitter and the base. Therefore, the output of the diode circuit 130A is at the L level, and the transistor Q1 is turned off. Additionally, the transistor Q3 is turned off because the input of the base is at the L level. Additionally, the transistor Q2 is turned on because the output of the diode circuit 130B is at the H level and the transistor Q3 is turned off.

When the transistor Q1 is turned off and the transistor Q2 is turned on, the relay 112 is switched from a state in which both of the relays 111 and 112 are connected to the ground (non-operating state with no water ingress) and is connected to the power source VB. Therefore, a current flows from the relay 112 toward the terminal 12, the terminal 11, and the relay 111, and the motor 10 rotates forward, thereby raising the window.

### Operation in UP Operation with Water Ingress

FIG. 3B is a diagram for explaining an example of an operation of the motor drive device 100 in the UP operation with water ingress.

In the UP operation with water ingress, if the MCU 150 operates normally, the output of the output terminal 151 of the MCU 150 becomes the L level, and the output of the output terminal 152 becomes the H level. If the MCU 150 is inoperable, the outputs of the output terminals 151 and 152 become undefined, which is neither the H level nor the L level. Therefore, in FIG. 3B, the output levels of the output terminals 151 and 152 are labeled in parentheses.

Additionally, the transistor Q4 of the water ingress detection circuit 140 is turned on because the base becomes the L level when the two pads of the water ingress detection section 141 conduct. Therefore, the output of the water ingress detection circuit 140 becomes the H level.

As a result, the H level signal is supplied to the one diode of each of the diode circuits 130A and 130B (the upper side in FIG. 2B). That is, regardless of whether the MCU 150 is operating normally or is inoperable, the H level signal is input to the one diode of each of the diode circuits 130A and 130B (the upper side in FIG. 2B).

At this time, as it is the UP operation, the input of the base of the transistor Q3 is at the L level, the transistor Q3 is turned off. As a result, the bases of the transistors Q1 and Q2 are at the H level, and both of the transistors Q1 and Q2 are turned on.

When both of the transistors Q1 and Q2 are turned on, both of the relays 111 and 112 are connected to the power source VB. As a result, the motor 10 is stopped in a state in which power is supplied from the power source VB to both of the terminals 11 and 12 of the motor 10.

When the UP operation is performed in the non-operating state with water ingress, the motor 10 is maintained in a state in which power is supplied from the power source VB to both of the terminals 11 and 12 of the motor 10, and thus the motor 10 is maintained in the stopped state. Therefore, even if the UP operation is erroneously performed in a state in which the window is opened to some extent in the presence of water ingress, the window is not closed and is kept open to some extent.

Additionally, when switching from a state of no water ingress to a state of water ingress during the UP operation, the motor 10 is maintained in a state in which power is supplied from the power source VB to both of the terminals 11 and 12 of the motor 10, so that the motor 10 rotating in the forward direction is stopped. Therefore, when switching to the state of water ingress, the motor 10 is stopped, and if the window is opened to some extent at that time, it is kept open.

### Operation in DOWN Operation with No Water Ingress

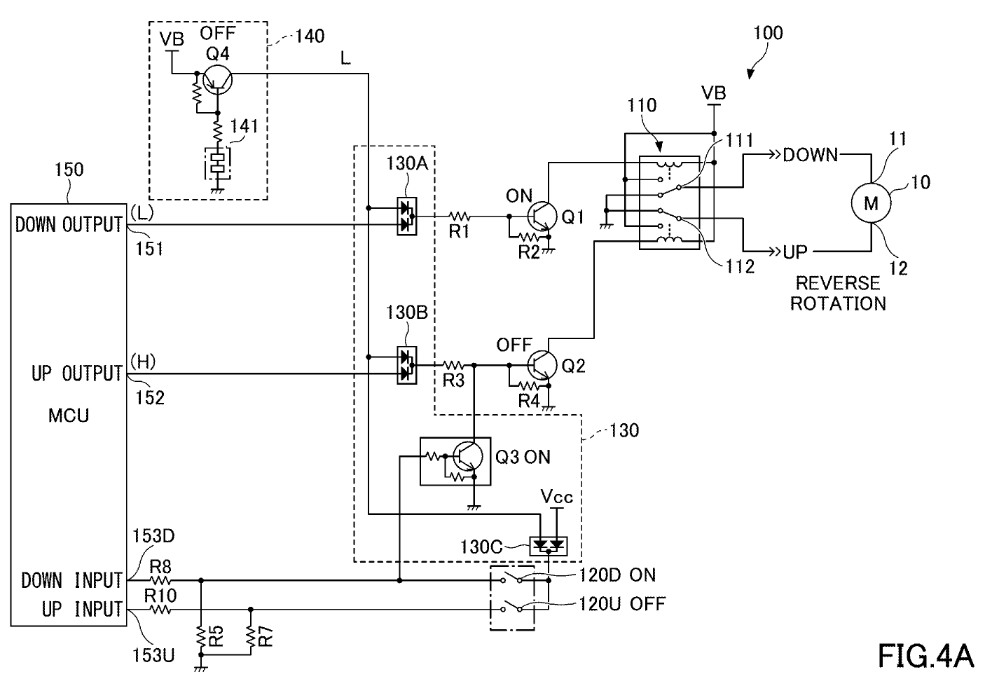

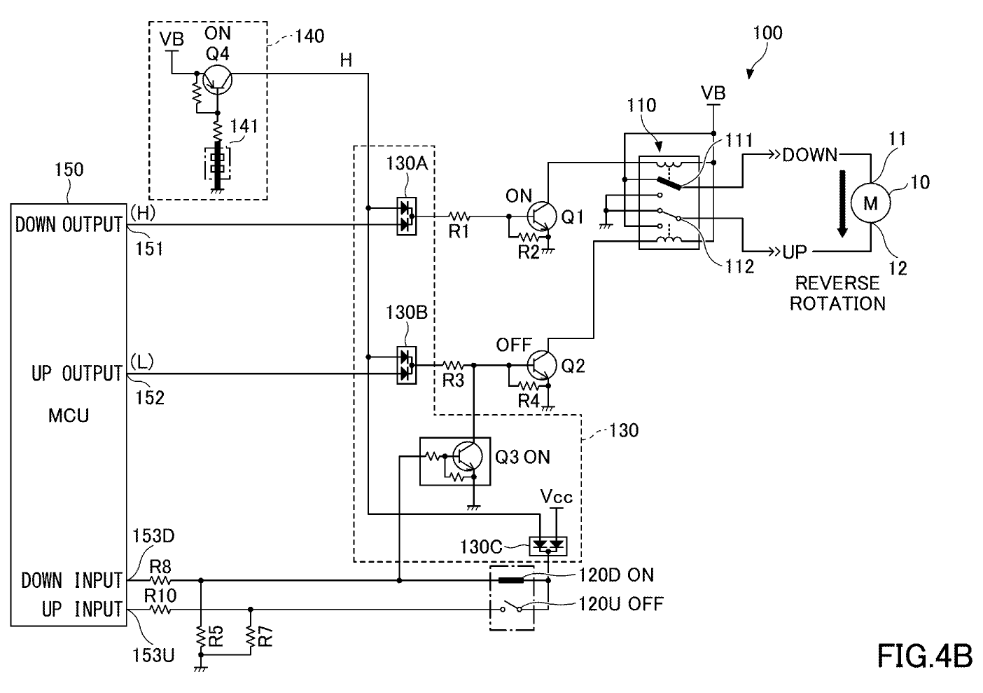

FIG. 4A is a diagram for explaining an example of an operation of the motor drive device 100 in the DOWN operation with no water ingress. The DOWN operation is an operation of the operator operating the operation switch 120D to lower the window.

The MCU 150 can operate normally in non-water ingress, in the DOWN operation with no water ingress, the MCU 150 determines that the DOWN operation is performed based on the input signal of the input terminal 153D, and sets the output of the output terminal 151 to the H level and the output of the output terminal 152 to the L level. Additionally, the transistor Q4 of the water ingress detection circuit 140 is turned off because the base is at the H level when power is supplied from the power source VB via the resistor between the emitter and the base. Therefore, the output of the diode circuit 130A is at the H level, and the transistor Q1 is turned on. Additionally, the transistor Q3 is turned on because the input of the base is at the H level. This is because power is supplied to the base of the transistor Q3 from the power source Vcc. Additionally, the output of the diode circuit 130B is at the L level, and the transistor Q3 is turned on. In this state, the transistor Q2 is turned off.

When the transistor Q1 is turned on and the transistor Q2 is turned off, the relay 111 is switched from a state in which both of the relays 111 and 112 are connected to the ground (in the non-operating state with water ingress) and is connected to the power source VB. Therefore, a current flows from the relay 111 toward the terminal 11, the terminal 12, and the relay 112, and the motor 10 reverses, thereby lowering the window.

### Operation in DOWN Operation with Water Ingress

FIG. 4B is a diagram for explaining an example of an operation of the motor drive device 100 in the DOWN operation with water ingress.

In the DOWN operation with water ingress, if the MCU 150 is operating normally, the output of the output terminal 151 of the MCU 150 becomes the H level, and the output of the output terminal 152 becomes the L level. If the MCU 150 is inoperable, the outputs of the output terminals 151 and 152 become undefined, which is neither the H level nor the L level. Therefore, in FIG. 4B, the output levels of the output terminals 151 and 152 are labeled in parentheses.

Additionally, the transistor Q4 of the water ingress detection circuit 140 is turned on because the base becomes the L level when the two pads of the water ingress detection section 141 conduct. Therefore, the output of the water ingress detection circuit 140 becomes the H level. As a result, the H level signal is supplied to the one diode of each of the diode circuits 130A and 130B (the upper side in FIG. 2B). That is, the H level signal is input to the one diode of each of the diode circuits 130A and 130B (the upper side in FIG. 2B) regardless of whether the MCU 150 is operating normally or is inoperable.

Additionally, as it is the DOWN operation, the input of the base of the transistor Q3 becomes H level. This is because the power source VB is supplied to the anode of one diode (the left side in FIG. 4B) of the diode circuit 130C via the water ingress detection circuit 140, and the power of the power source VB is input to the base of the transistor Q3 as the H level signal. Here, at this time, if the MCU 150 is operating normally, the power source Vcc is supplied to the anode of the other diode (the right side in FIG. 4B) of the diode circuit 130C. If the MCU 150 is inoperable, the power source Vcc is not supplied, but the power source VB is supplied to the anode of one diode (the left side in FIG. 4B) of the diode circuit 130C. Therefore, the diode circuit 130C outputs the H level signal based on the power source VB to the base of the transistor Q3 regardless of whether the power source Vcc is supplied.

As a result, the transistor Q3 is turned on, and the base of the transistor Q2 is connected to the ground through the emitter and collector of the transistor Q3, and thus the base is turned to the L level. As a result, the base of the transistor Q1 becomes the H level, the base of the transistor Q2 becomes the L level, the transistor Q1 is turned on, and the transistor Q2 is turned off.

In the state in which the transistor Q1 is on and the transistor Q2 is off, the relay 111 is connected to the power source VB and the relay 112 is connected to the ground. As a result, a current flows from the relay 111 toward the terminal 11, the terminal 12, and the relay 112, and the motor 10 reverses to lower the window. That is, when the operation switch 120D is operated in the presence of water ingress, the power source VB is connected to the transistor Q3, and the transistor Q3 operates the transistor Q2, thereby rotating the motor 10 in the first direction (the DOWN direction).

When the DOWN operation is performed in the non-operating state with water ingress, the relay 112 switches to the ground while power is supplied from the power source VB to both of the terminals 11 and 12 of the motor 10, and thus the motor 10 reverses to lower the window. A current flows to the motor 10 by switching the relay 112 to the ground from the state in which power is supplied from the power source VB to both of the terminals 11 and 12 of the motor 10, and thus the motor 10 can be caused to reverse to lower the window more reliably and stably, in comparison with the case where a current flows to the motor 10 from the state in which power is not supplied to both of the terminals 11 and 12 of the motor 10.

Additionally, when non-water ingress is switched to water ingress in the DOWN operation, the motor 10 can be caused to reverse to lower the window while maintaining the connection state of the relays 111 and 112 in the DOWN operation in the absence of water ingress without switching the relays 111 and 112.

Additionally, the configuration in which both of the relays 111 and 112 are connected to the ground in the non-operating state with no water ingress and both of the relays 111 and 112 are connected to the power source VB in the non-operating state with the water ingress has been described above. However, both of the relays 111 and 112 may be connected to the power source VB in the non-operating state with no water ingress, and both of the relays 111 and 112 may be connected to the ground in the non-operating state with water ingress. In this case, for example, the connection relationships are switched in the connection paths from the transistors Q2 and Q3 to the terminals 11 and 12 of the motor 10. More specifically, the connection relationships between the relays 111 and 112 and the terminals 11 and 12 of the motor 10 are switched, and the relay 112 is switched to be connected to the power source VB in the DOWN operation with water ingress.

### Motor Drive Device 100M according to Modified Example of Embodiment

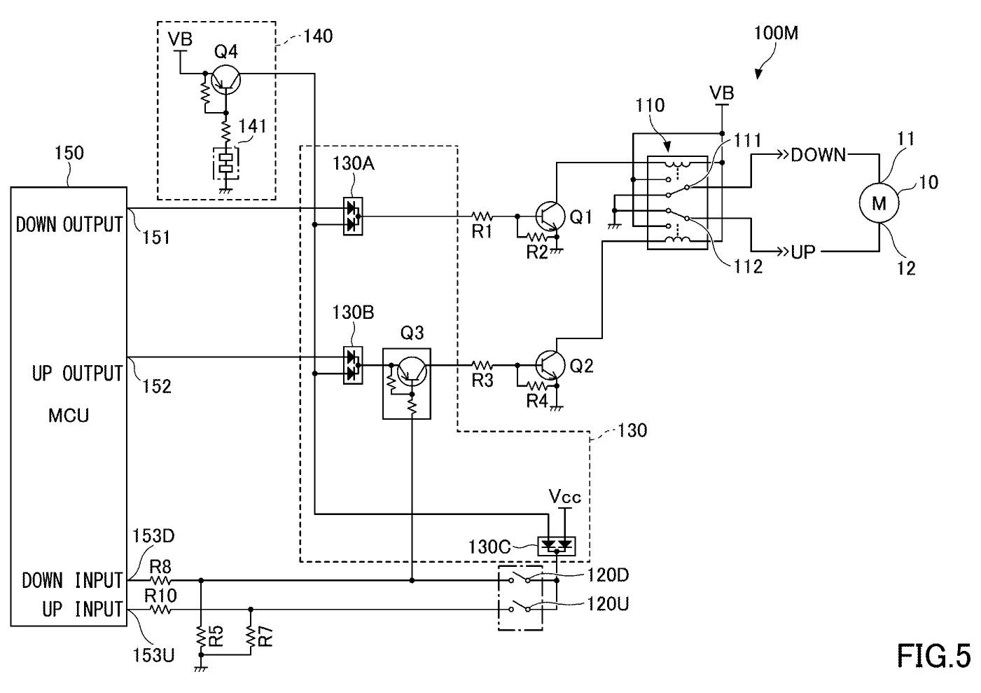

FIG. 5 is a diagram illustrating an example of a motor drive device 100M according to a modified example of the embodiment. The motor drive device 100M is mounted on a vehicle and controls the drive of the motor 10 configured to open and close an opening and closing body such as a window of the vehicle. Here, a circuit configuration of the motor drive device 100M will be described with reference to FIG. 5. The same reference numerals are used for the same components as those of the motor drive device 100 illustrated in FIG. 1, and description thereof will be omitted.

The motor drive device 100M has a configuration in which the transistor Q3 of the motor drive device 100 illustrated in FIG. 1 is changed to a PNP bipolar transistor and the connection relationship is changed.

In the motor drive device 100M, the transistor Q3 is the same as the transistor Q3 of the motor drive device 100 illustrated in FIG. 1 in that the base of the transistor Q3 is connected to one end (the left terminal in FIG. 5) of the operation switch 120D.

In the motor drive device 100M, the connection destinations of the collector and the emitter of the transistor Q3 are different from those of the transistor Q3 of the motor drive device 100 illustrated in FIG. 1.

In the motor drive device 100M, the emitter of the transistor Q3 is connected to the output terminal of the diode circuit 130B, and the collector is connected to the base of the transistor Q2.

### Operation in Non-operating State with No Water Ingress

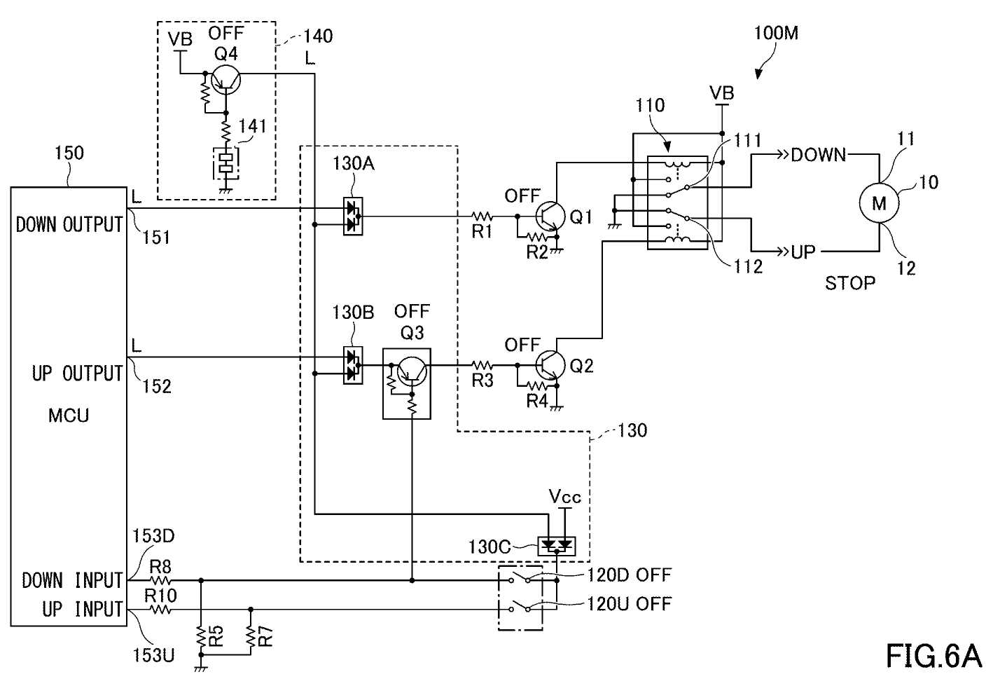

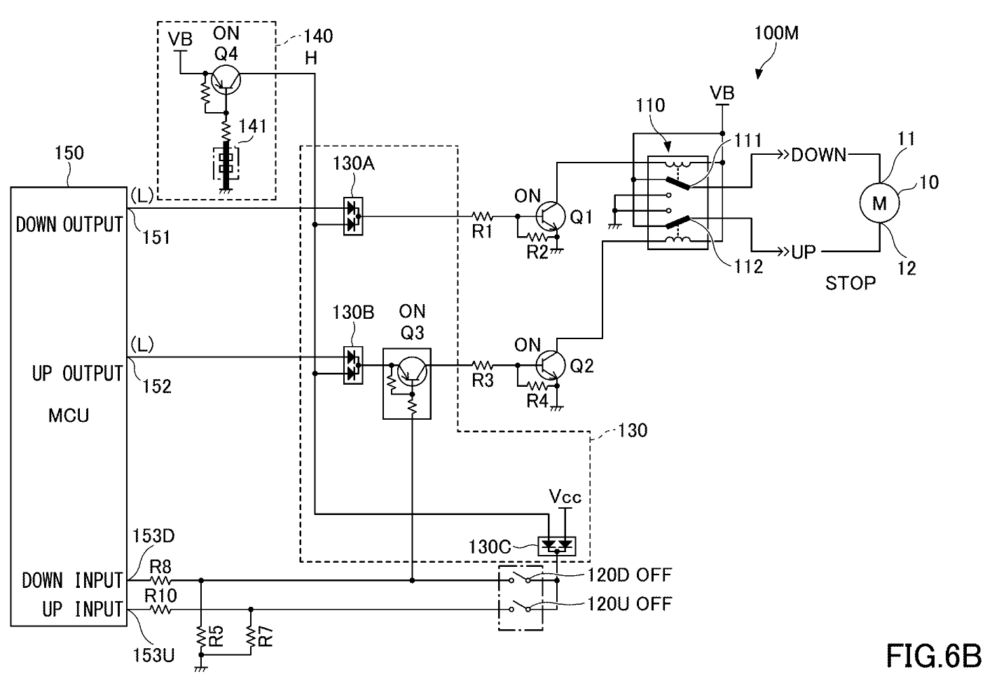

FIG. 6A is a diagram for explaining an example of an operation of the motor drive device 100M in the non-operating state with no water ingress.

The MCU 150 can operate normally in the absence of water ingress, and thus the outputs of the output terminals 151 and 152 of the MCU 150 become the L level in the non-operating state with no water ingress. Additionally, the transistor Q4 of the water ingress detection circuit 140 is turned off because the base is at the H level due to the power supplied from the power source VB via the resistor between the emitter and the base. Therefore, the output of the water ingress detection circuit 140 is at the L level.

As a result, the output of the diode circuit 130A is at the L level, and the transistor Q1 is turned off. Additionally, the output of the diode circuit 130B is at the L level, and thus the input to the emitter of the transistor Q3 becomes the L level and the input to the base also becomes the L level. Therefore, the transistor Q3 is turned off, and the transistor Q2 is turned off because the base is at the L level.

When both of the transistors Q1 and Q2 are turned off, the relays 111 and 112 are connected to the ground. Therefore, no current flows to the motor 10, and the motor 10 is stopped.

### Operation in Non-operating State with Water Ingress

FIG. 6B is a diagram for explaining an example of an operation of the motor drive device 100M in the non-operating state with water ingress.

In the non-operating state with water ingress, the outputs of the output terminals 151 and 152 of the MCU 150 become the L level if the MCU 150 operates normally, and become undefined, which is neither the H level nor the L level, if the MCU 150 is inoperable. Therefore, in FIG. 6B, the output levels of the output terminals 151 and 152 are labeled in parentheses.

Additionally, the transistor Q4 of the water ingress detection circuit 140 is turned on because the base is at the L level when the two pads of the water ingress detection section 141 conduct. Therefore, the output of the water ingress detection circuit 140 becomes the H level.

As a result, the H level signal is supplied to the one diode of each of the diode circuits 130A and 130B (the upper side in FIG. 6B). That is, the H level signal is input to the one diode of each of the diode circuits 130A and 130B (the upper side in FIG. 2B) regardless whether the MCU 150 is operating normally or is inoperable.

At this time, as this is a non-operating state, the input of the base of the transistor Q3 is at the L level, and thus the transistor Q3 is turned on. As a result, the bases of the transistors Q1 and Q2 become the H level, and both of the transistors Q1 and Q2 are turned on.

When both of the transistors Q1 and Q2 are turned on, both of the relays 111 and 112 are switched and connected to the power source VB. Therefore, the terminals 11 and 12 of the motor 10 becomes the same potential, and no current flows to the motor 10, and thus the motor 10 is stopped. In the non-operating state with water ingress, the motor 10 is stopped in a state in which power is supplied from the power source VB to both of the terminals 11 and 12 of the motor 10. The power source VB is directly connected to the battery of the vehicle, and thus power is supplied even in the presence of water ingress.

### Operation in UP Operation with No Water Ingress

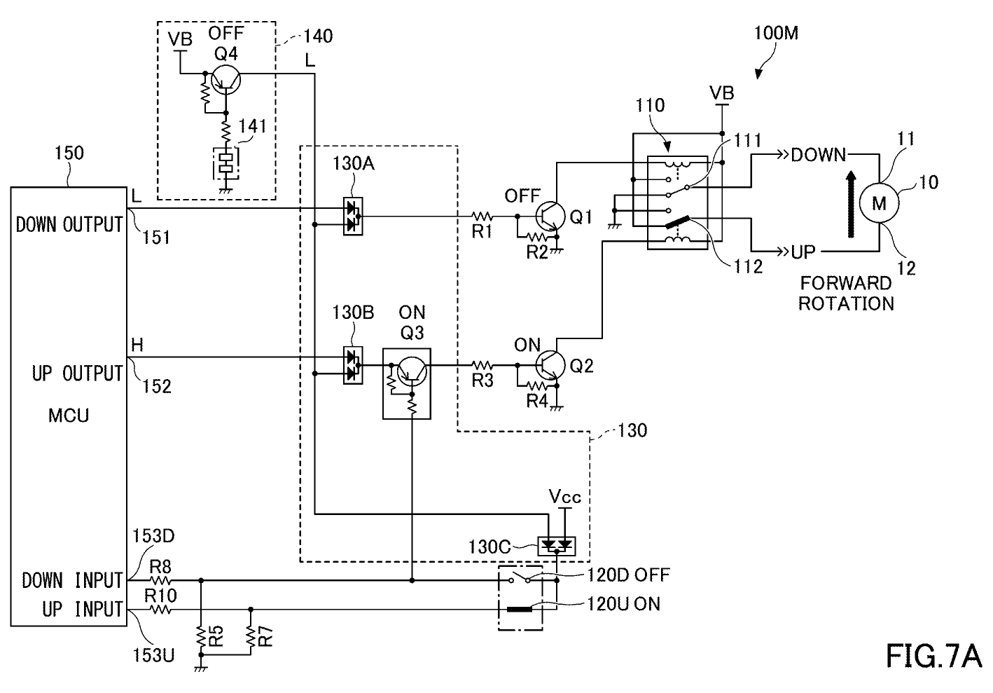

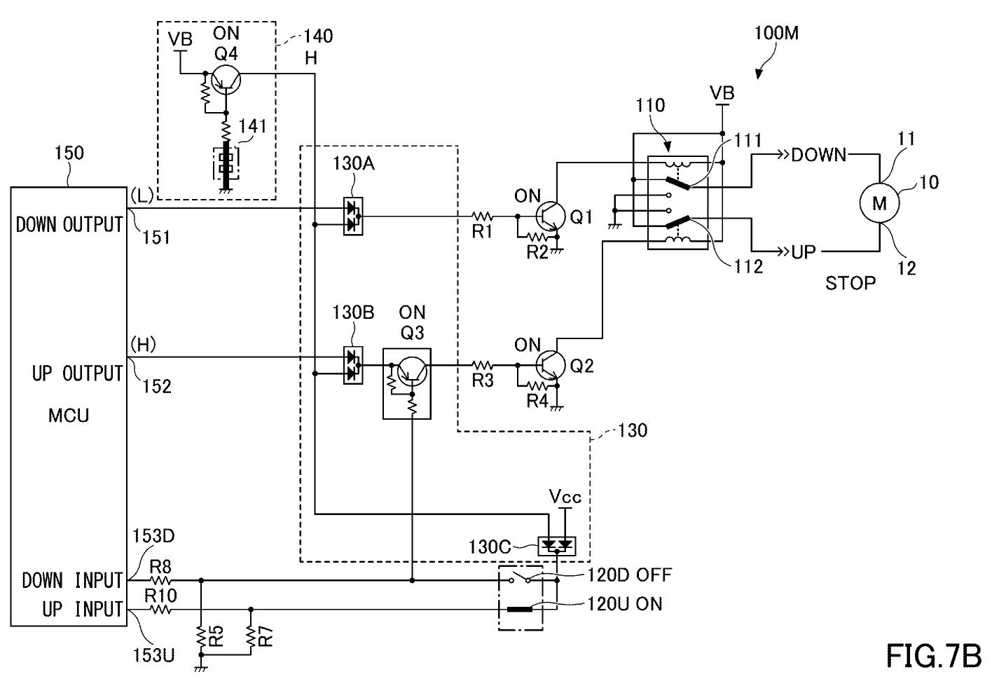

FIG. 7A is a diagram for explaining an example of an operation of the motor drive device 100M in the UP operation with no water ingress.

In the UP operation with no water ingress, as in the case of the UP operation in the non-water ingress in the motor drive device 100 (see FIG. 3A), the output of the output terminal 151 becomes the L level and the output of the output terminal 152 becomes the H level. As water ingress into the vehicle has not occurred, the output of the water ingress detection circuit 140 is the L level.

Therefore, the output of the diode circuit 130A is the L level and the transistor Q1 is turned off. Additionally, the input of the base is the L level and the transistor Q3 is turned on. Additionally, the output of the diode circuit 130B is the H level and the transistor Q3 is turned on, and thus the transistor Q2 is turned on.

When the transistor Q1 is off and the transistor Q2 is on, the relay 112 is switched from a state in which both of the relays 111 and 112 are connected to the ground (in the non-operating state with no water ingress) and is connected to the power source VB. Therefore, a current flows from the relay 112 toward the terminal 12, the terminal 11, and the relay 111, and the motor 10 rotates forward, thereby raising the window.

### Operation in UP Operation with Water Ingress

FIG. 7B is a diagram for explaining an example of an operation of the motor drive device 100M in the UP operation with water ingress.

In the UP operation with water ingress, if the MCU 150 operates normally, the output of the output terminal 151 of the MCU 150 becomes the L level, and the output of the output terminal 152 becomes the H level. If the MCU 150 is inoperable, the outputs of the output terminals 151 and 152 become undefined, which is neither H level nor L level. Therefore, in FIG. 7B, the output levels of the output terminals 151 and 152 are labeled in parentheses.

Additionally, in the presence of water ingress, the transistor Q4 of the water ingress detection circuit 140 is turned on, and thus the output of the water ingress detection circuit 140 becomes the H level.

As a result, the H level signal is supplied to the one diode of each of the diode circuits 130A and 130B (the lower side in FIG. 7B). That is, the H level signal is input to the one diode of each of the diode circuits 130A and 130B (the lower side in FIG. 7B) regardless of whether the MCU 150 is operating normally or is inoperable.

At this time, as it is the UP operation, the input of the base of the transistor Q3 is the L level, and thus the transistor Q3 is turned on. As a result, the bases of the transistors Q1 and Q2 become the H level, and both of the transistors Q1 and Q2 are turned on.

When both of the transistors Q1 and Q2 are turned on, both of the relays 111 and 112 are connected to the power source VB. As a result, the motor 10 is stopped in a state in which power is supplied from the power source VB to both of the terminals 11 and 12 of the motor 10.

That is, in the UP operation with water ingress in the motor drive device 100M, the same operation and the same effect can be obtained as those in the UP operation with water ingress in the motor drive device 100 (see FIG. 3B).

### Operation in DOWN Operation with No Water Ingress

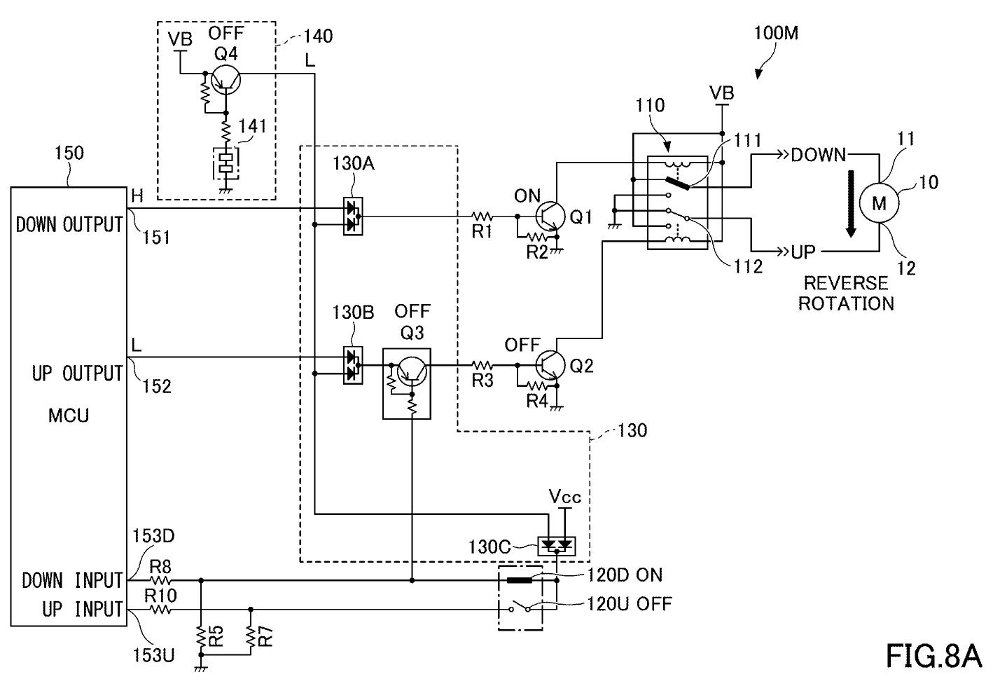

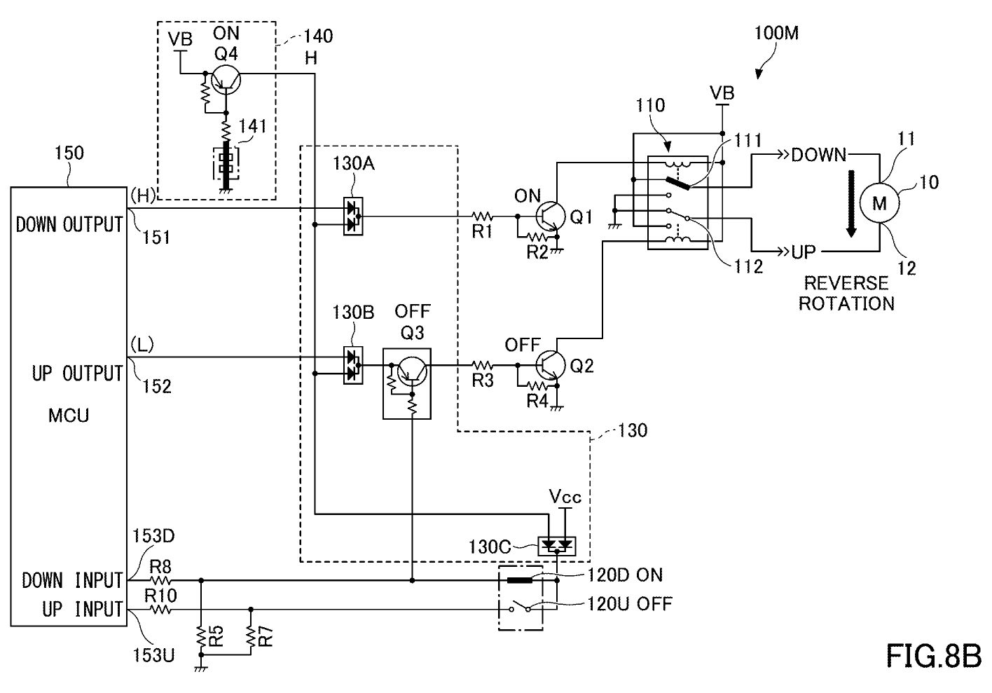

FIG. 8A is a diagram for explaining an example of an operation of the motor drive device 100M in the DOWN operation with no water ingress.

In the DOWN operation with no water ingress, as in the case of the DOWN operation with no water ingress in the motor drive device 100 (see FIG. 4A), the output of the output terminal 151 becomes the H level and the output of the output terminal 152 becomes the L level. As water ingress into the vehicle has not occurred, the output of the water ingress detection circuit 140 is the L level.

Therefore, the output of the diode circuit 130A is at the H level, and the transistor Q1 is turned on. Additionally, the input of the emitter of the transistor Q3 is at the L level and the input of the base is at the H level, and thus the transistor Q3 is turned off. This is because power is supplied to the base of the transistor Q3 from the power source Vcc and the L level is input from the diode circuit 130B. Additionally, because the transistor Q3 is turned off, the base of the transistor Q2 is at the L level, and the transistor Q2 is turned off.

When the transistor Q1 is turned on and the transistor Q2 is turned off, the relay 111 is switched to be connected to the power source VB from a state in which both of the relays 111 and 112 are connected to the ground (in the non-operating state with no water ingress). Therefore, a current flows from the relay 111 toward the terminal 11, the terminal 12, and the relay 112, and the motor 10 reverses to lower the window.

### Operation in DOWN Operation with Water Ingress

FIG. 8B is a diagram for explaining an example of an operation of the motor drive device 100M in the DOWN operation with water ingress.

In the DOWN operation with water ingress, as in the DOWN operation with water ingress in the motor drive device 100 (see FIG. 4B), if the MCU 150 operates normally, the output terminal 151 of the MCU 150 becomes the H level and the output terminal 152 becomes the L level. If the MCU 150 is inoperable, both of the outputs of the output terminals 151 and 152 become undefined, which is neither the H level nor the L level. Therefore, in FIG. 8B, the output levels of the output terminals 151 and 152 are labeled in parentheses.

Additionally, as water ingress into the vehicle has occurred, the output of the water ingress detection circuit 140 becomes the H level. As a result, the H level signal is supplied to the one diode of each of the diode circuits 130A and 130B (the lower side in FIG. 8B). That is, the H level signal is input to the one diode of each of the diode circuits 130A and 130B (the lower side in FIG. 8B) regardless of whether the MCU 150 is operating normally or is inoperable.

Additionally, as it is the DOWN operation, the input of the base of the transistor Q3 becomes the H level. This is because the power source VB is supplied to the anode of one diode (the left side in FIG. 8B) of the diode circuit 130C via the water ingress detection circuit 140, and the power of the power source VB is input to the base of the transistor Q3 as the H level signal. Here, at this time, if the MCU 150 is operating normally, the power source Vcc is supplied to the anode of the other diode (the right side in FIG. 8B) of the diode circuit 130C. If the MCU 150 is inoperable, the power source Vcc is not supplied, but the power source VB is supplied to the anode of one diode (the left side in FIG. 8B) of the diode circuit 130C. Therefore, the diode circuit 130C outputs the H level signal based on the power source VB to the base of the transistor Q3 regardless of whether the power source Vcc is supplied.

As a result, the transistor Q3 is turned off, and the L level is input to the base of the transistor Q2. Therefore, the base of the transistor Q1 becomes the H level, the base of the transistor Q2 becomes the L level, the transistor Q1 is turned on, and the transistor Q2 is turned off.

When the transistor Q1 is turned on and the transistor Q2 is turned off, the relay 111 is connected to the power source VB, and the relay 112 is connected to the ground. That is, the operation of the relay 112 can be stopped such that the relay 112 is not connected to the power source VB. As a result, a current flows from the relay 111 toward the terminal 11, the terminal 12, and the relay 112, and the motor 10 reverses to lower the window.

That is, in the DOWN operation with water ingress in the motor drive device 100M, the same operation and the same effect can be obtained as those in the DOWN operation with water ingress in the motor drive device 100 (see FIG. 4B).

Additionally, the configuration in which both of the relays 111 and 112 are connected to the ground in the non-operating state with no water ingress, and both of the relays 111 and 112 are connected to the power source VB in the non-operating state with water ingress has been described above. However, both of the relays 111 and 112 may be connected to the power source VB in the non-operating state with no water ingress, and both of the relays 111 and 112 may be connected to the ground in the non-operating state with water ingress. In this case, for example, the connection relationships are exchanged in the connection paths from the transistors Q2 and Q3 to the terminals 11 and 12 of the motor 10. More specifically, the connection relationships between the relays 111 and 112 and the terminals 11 and 12 of the motor 10 are exchanged, and the relay 112 is switched to be connected to the power source VB in the DOWN operation with water ingress.

### Effect

The motor drive device 100 includes the relay 111 (the first switcher) configured to switch either the terminal 11 (the first terminal) or the terminal 12 (the second terminal) of the motor 10 to be connected to the power source VB (the first power source) or the ground (the reference potential point); the relay 112 (the second switcher) configured to switch either the terminal (11) (the first terminal) or the terminal 12 (the second terminal) of the motor 10 to be connected to the power source VB or the ground; the operation switch 120D (the first operation switch) operated when the motor 10 is caused to rotate in the first direction (the DOWN direction); the operation switch 120U operated when the motor 10 is caused to rotate in the second direction (the UP direction); the transistor Q1 (the first switching element) configured to drive the relay 111; the transistor Q2 (the second switching element) configured to drive the relay 112; the transistor Q3 (the third switching element) connected to the transistor Q2; the MCU 150 (the controller) configured to operate the transistor Q1 based on the operation of the operation switch 120D and operate the transistor Q2 based on the operation of the operation switch 120U; and the water ingress detection circuit 140 configured to output the water ingress detection signal when water ingress is detected and switches the relay 111 and the relay 112 by operating the transistor Q1 and the transistor Q2 based on the water ingress detection signal. The water ingress detection circuit 140 includes the transistor Q4 (the fourth switching element) configured to operate when the water ingress is detected and output the water ingress detection signal. One end of the operation switch 120D is connected to the transistor Q3 and the MCU 150, and the other end is connected to the power source VB via the transistor Q4 and connected to the power source Vcc (the second power source). When the operation switch 120D is operated when the water ingress is detected, the power source VB is connected to the transistor Q3 and the transistor Q3 operates the transistor Q1 or the transistor Q2, thereby rotating the motor 10 in the first direction (the DOWN direction).

As described above, when operated in the presence of water ingress, the motor 10 is caused to rotate in the first direction (DOWN direction) by connecting the power source VB to the transistor Q3 and causing the transistor Q3 to operate the transistor Q1 or the transistor Q2, so that the transistor Q3 can be stably operated and the circuit operation of the motor drive device 100 can be stabilized.

Therefore, the motor drive device 100 that can achieve a stable circuit operation even when water ingress into the vehicle has occurred can be provided.

Additionally, the motor drive device may further include the first diode (the diode on the left side of the diode circuit 130C) connected between the operation switch 120D and the power source VB, and the second diode (the diode on the right side of the diode circuit 130C) connected between the operation switch 120D and the power source Vcc. When water ingress into the vehicle has occurred, the first power source is connected to the operation switch 120D via the first diode (the diode on the left side of the diode circuit 130C), thereby causing the transistor Q3 to operate the transistor Q1 or the transistor Q2 to rotate the motor 10 in the first direction (the DOWN direction). Additionally, by using the first diode and the second diode, even if the voltages of the power source VB and the power source Vcc are different, reverse flow can be prevented.

Additionally, the transistor Q3 may be a switching element configured to switch the connection state between the transistor Q2 and the ground. In the motor drive device 100, when the transistor Q3 conducts, the transistor Q2 is connected to the ground, thereby stopping the operation of the relay 112 so that the relay 112 is not switched. As a result, the motor 10 can be caused to rotate in the first direction (the DOWN direction).

Additionally, one end of the operation switch 120D is connected to the control terminal of the transistor Q3, and when the operation switch 120D is operated in the presence of water ingress, the power source VB is connected to the base (the control terminal) of the transistor Q3, and the transistor Q3 conducts and the control terminal of the transistor Q2 is connected to the ground, so that the transistor Q2 may become non-conducting. The power source VB is connected to the base of the transistor Q3 via the operation switch 120D, and thus the operation of the transistor Q3 becomes stable.

Additionally, the transistor Q3 may be a switching element configured to switch the connection state of the transistor Q2 with respect to the MCU 150 and the water ingress detection circuit 140. In the motor drive device 100M, which is the modified example, the transistor Q3 can stop the operation of the relay 112 such that the relay 112 is not connected to the power source VB by switching the connection state between the transistor Q2 and the MCU 150. As a result, the motor 10 can be caused to rotate in the first direction (the DOWN direction).

Additionally, one end of the operation switch 120D is connected to the base of the transistor Q3, and the connection point between the base of the transistor Q3 and the one end of the operation switch 120D is connected to the ground via the resistor R5. When the operation switch 120D is operated in the presence of water ingress, the base of the transistor Q3 is connected to the power source VB, the transistor Q3 becomes non-conducting, the connection between the base of the transistor Q2 and the water ingress detection circuit 140 becomes non-conducting, so that the transistor Q2 may become non-conducting. In the DOWN operation with water ingress, the relay 112 is switched and connected to the ground, thereby rotating the motor 10 in the first direction (DOWN direction).

Although the motor drive device according to the exemplary embodiments of the present disclosure has been described above, the present disclosure is not limited to the embodiments specifically disclosed, and various modifications and changes can be made without departing from the scope of the claims.

What is claimed is:

1. A motor drive device comprising:
a first switcher configured to switch to connect one terminal among a first terminal and a second terminal of a motor to a first power source or a reference potential point;
a second switcher configured to switch to connect another terminal among the first terminal and the second terminal of the motor to the first power source or the reference potential point;
a first operation switch operated when the motor is caused to rotate in a first direction;
a second operation switch operated when the motor is caused to rotate in a second direction;
a first switching element configured to drive the first switcher;
a second switching element configured to drive the second switcher;
a third switching element connected to the second switching element;
a controller configured to operate the first switching element based on an operation of the first operation switch and operate the second switching element based on an operation of the second operation switch; and
a water ingress detection circuit configured to output a water ingress detection signal in response to detecting water ingress and switch the first switcher and the second switcher by operating the first switching element and the second switching element in accordance with the water ingress detection signal,
wherein the water ingress detection circuit includes a fourth switching element configured to operate in the presence of water ingress and output the water ingress detection signal;
wherein one end of the first operation switch is connected to the third switching element and the controller, and another end of the first operation switch is connected to the first power source via the fourth switching element and connected to a second power source,
wherein, when the first operation switch is operated in the presence of water ingress, the first power source is connected to the third switching element and the third switching element operates the second switching element to rotate the motor in the first direction.

2. The motor drive device as claimed in claim 1, further comprising:
a first diode connected between the first operation switch and the first power source; and
a second diode connected between the first operation switch and the second power source.

3. The motor drive device as claimed in claim 1, wherein the third switching element is configured to switch a connection state between the second switching element and the reference potential point.

4. The motor drive device as claimed in claim 3,
wherein the one end of the first operation switch is connected to a control terminal of the third switching element,
wherein, when the first operation switch is operated in the presence of water ingress, the first power source is connected to the control terminal of the third switching element, the third switching element conducts, and a control terminal of the second switching element is connected to the reference potential point, so that the second switching element becomes non-conducting.

5. The motor drive device as claimed in claim 1, wherein the third switching element is configured to switch a connection state of the second switching element with respect to the controller and the water ingress detection circuit.

6. The motor drive device as claimed in claim 5,
wherein the one end of the first operation switch is connected to the control terminal of the third switching element, a connection point between the control terminal of the third switching element and the one end of the first operation switch is connected to the reference potential point via a resistor, and
wherein, when the first operation switch is operated in the presence of water ingress, the first power source is connected to the control terminal of the third switching element, the third switching element becomes non-conducting, and a connection between a control terminal of the second switching element and the water ingress detection circuit becomes non-conducting, so that the second switching element becomes non-conducting.
